(19) United States
(12) Patent Application Publication
(10) Pub. No.: US 2025/0018818 A1
(43) Pub. Date: Jan. 16, 2025

(54) VEHICLE CHARGING MANAGEMENT BASED ON VARIABLE CHARGING WINDOWS

(71) Applicant: Tesla, Inc., Austin, TX (US)

(72) Inventors: Anand Swaminathan, Sunnyvale, CA (US); Monica Lin, Redwood City, CA (US); Rajakumar Ganne, Mountain View, CA (US); Harshad Kunte, Santa Clara, CA (US); Christopher Satkoski, San Jose, CA (US)

(21) Appl. No.: 18/714,313

(22) PCT Filed: Dec. 1, 2022
(86) PCT No.: PCT/US2022/051551

§ 371 Date: May 29, 2024

Related U.S. Application Data
(60) Provisional application No. 63/264,928, filed on Dec. 3, 2021.

(51) Int. Cl. B60L 53/65; B60L 53/64; B60L 53/66

(52) U.S. Cl. CPC B60L 53/65; B60L 53/64; B60L 53/665

(57) ABSTRACT

The charging management system based on variable charging windows is disclosed. The system can receive and/or determine an anticipated/desired time for the beginning operation of the vehicle. The system obtains or identifies preferences for charging metrics, including desired charge, battery pack preconditioning, and other vehicle attributes. The system then determines a required start time for the desired charging metrics. Illustratively, the determined start time can be based on ambient environmental conditions that can influence charging times, such as differences in charging times based on temperature. The determined start time can also be based on rate schedules for one or more power sources, such as one or more off-peak charging rates, peak charging rates, etc.

### INCORPORATION BY REFERENCE TO ANY PRIORITY APPLICATIONS

This application is a non-provisional of and claims priority to U.S. Provisional Patent Application No. 63/264,928, entitled “VEHICLE CHARGING MANAGEMENT BASED ON VARIABLE CHARGING WINDOWS,” filed on Dec. 3, 2021, which is hereby incorporated by reference in its entirety and for all purposes.

### BACKGROUND

### Technical Field

The disclosed technology relates to electric power charging.

### Background

Generally described, a variety of vehicles, such as electric vehicles, hybrid vehicles, etc., can require some connection to an external power source to at least partially recharge internal power sources, such as a battery pack. In certain scenarios, the electric vehicle user may wish to begin a charging process so that at least the battery pack is considered fully charged prior to use.

Generally described, computing devices and communication networks can be utilized to exchange data and/or information. In a common application, a computing device can request content from another computing device via the communication network. For example, a user at a personal computing device can utilize a browser application to request a content page (e.g., a network page, a Web page, etc.) from a server computing device via the network (e.g., the Internet). In such embodiments, the user computing device can be referred to as a client computing device and the server computing device can be referred to as a service provider. In another embodiment, the user computing device can collect or generate information and provide the collected information to a server computing device for further processing or analysis.

### SUMMARY

The innovations described in the claims each have several aspects, no single one of which is solely responsible for its desirable attributes. Without limiting the scope of the claims, some prominent features of this disclosure will now be briefly described.

One aspect of this disclosure is a battery charging system (or vehicle charging system). The system is configured to determine a desired time for beginning operation of a vehicle, wherein the vehicle is associated with a battery pack; identify preference information for charging the battery pack associated with the vehicle, wherein the preference information includes a desired charging threshold; identify charging metric information and external information for at least one power source operable to provide energy to the battery pack; determine at least one charging window based at least on the preference information, the charging metric information, and the external information; and implement battery pack charging from the at least one power source based on the identified at least one charging window.

In this aspect, the charging management application identifies the at least one charging window by: identifying a plurality of charging power sources, wherein the charging power sources are available to provide energy to the battery pack; selecting a first charging power source of the plurality of charging power sources; determining a first charging window for the first charging power source and an estimated cost for implementing the first charging window; in response to determining that the estimated cost exceeds a financial threshold identified in the preference information, selecting a second charging power source from the plurality of charging power sources; and determining a second charging window for the second charging power source.

In the above aspect, the charging management application determines at least the first charging window or the second charging window based on: determining an off-peak charging rate end times based on a charging power source, wherein the off-peak charging rate end times represent a desired termination time of the at least one charging window; calculating a required charging start time based at least on environmental information included in the identified external information, wherein the environmental information includes an ambient temperature; determining charging windows corresponding to the off-peak charging rate end times; and in response to determining that the charging windows correspond to the off-peak charging rate, selecting the first or the second charging window for the determined charging windows corresponding to the off-peak charging rate end times.

The preference information in the above aspect includes at least one of desired charge information and battery pack preconditioning information, wherein the desired charge information includes at least one of the categories of charge, numerical values corresponding to battery pack charging states, or equivalent ranges of operational uses for the vehicle associated with the battery pack, and wherein the battery pack preconditioning information includes operational patterns associated with the battery pack.

At least one power source in the above aspect is associated with charging metrics, wherein the charging metrics include at least one of charging rates, charging restrictions, and information associated with a utilization of the power source to charge the vehicle.

The external information in the above aspect corresponds to charging models for generating battery pack charge states by application of power from at least one power source, wherein the charging models define a functionality of at least one power source.

The system in the above aspect is further configured to select the at least one charging window based on comparison of charging windows associated with different power sources.

The charging management application in the above aspect implements a single identified charging window.

The charging management application in the above aspect implements multiple identified charging windows.

The preference information in the above aspect includes financial metrics and wherein the financial metrics include at least one of the maximum charges, maximum charging rates, and selection of least cost charging window associated with multiple power sources.

Another aspect of this disclosure is a system for managing vehicle charging, the system comprising: identifying preference information for charging a battery pack included in a vehicle; identifying charging metric information and external information for at least one power source available for providing power to the battery pack; and identifying at least one charging window based on anticipated use of the battery back and on the preference information, the charging metric information, and the external information.

The identifying at least one charging window in the above aspect is based on anticipated use of the battery back and on the preference information, the charging metric information, and the external information includes: identifying a plurality of power sources available for providing power to the battery pack; selecting a first charging power source from the plurality of power sources; determining a first charging window for the first charging power source and an estimated cost for implementing the first charging window; in response to determining that the estimated cost exceeds the threshold, selecting a second charging power source from the plurality of power sources; and determining a second charging window for the second charging power source.

Determining at least the first charging window or the second charging window in this aspect comprises: wherein includes: determining an off-peak charging rate end times based on a charging power source, wherein the off-peak charging rate end times represent a desired termination time of the charging windows corresponding to the anticipated use of the battery pack; calculating a required charging start time based at least on environmental information, wherein the environmental information includes an ambient temperature; determining charging windows corresponding to the off-peak charging rate end times; and in response to determining that the charging windows correspond to the off-peak charging rate, selecting the first and second charging window from the charging windows corresponding to the off-peak charging rate end times.

The preference information in this aspect includes at least one of desired charge information and battery pack preconditioning information, wherein the desired charge information includes categories of charge, numerical values, and/or equivalent ranges of operational uses, and wherein the battery pack preconditioning information includes operational patterns associated with the battery pack.

The power source in this aspect is associated with charging metrics, wherein the charging metrics include at least one of charging rates, charging restrictions, and information associated with a utilization of the power source to charge the vehicle.

The external information in this aspect corresponds corresponds to charging models, wherein the charging models define a functionality of charging components.

The preference information in this aspect includes financial metrics and wherein the financial metrics include at least one of maximum charges, maximum charging rates, and selection of least cost charging window associated with multiple power sources.

Another aspect of the present disclosure is a computer-implemented method for managing vehicle charging, the method comprising: determining a desired time for beginning operation of a vehicle; identifying preference information for charging battery packs included in the vehicle; identifying charging metric information and external information for at least one power source; identifying at least one charging window based at least on the desired time for beginning the operation of the vehicle, the preference information, the charging metric information, and the external information; and implementing vehicle charging based on the identified at least one charging window.

The identification of the at least one charging window in this aspect comprises: identifying a plurality of charging power sources, wherein the charging power sources are available to provide an electrical charge to the vehicle; selecting a first charging power source of the plurality of power sources; determining a first charging window for the first charging power source and an estimated cost for implementing the first charging window; in response to determining that the estimated cost exceeds the threshold, selecting a second charging power source from the plurality of power sources; and determining a second charging window for the second charging power source.

The determination at least the first charging window or the second charging window includes: determining an off-peak charging rate end times based on the charging power source, wherein the off-peak charging rate end times represent a desired termination time of the at least one charging window; calculating a required charging start time based at least on environmental information, wherein the environmental information includes an ambient temperature; determining charging windows corresponding to the off-peak charging rate end times; and in response to determining that the charging windows corresponding to the off-peak charging rate, selecting the first charging window or the second charging window from the charging windows corresponding to the off-peak charging rate end times.

The preference information in this aspect includes at least one of desired charge information and battery pack preconditioning information, wherein the desired charge information includes categories of charge, numerical values, and/or equivalent ranges of operational uses, and wherein the battery pack preconditioning information includes operational patterns associated with the battery pack.

The power source in this aspect is associated with charging metrics, wherein the charging metrics include at least one of charging rates, charging restrictions, and information associated with a utilization of the power source to charge the vehicle.

The external information in this aspect corresponds to charging models, wherein the charging models define a functionality of charging components.

The method further includes selecting the at least one charging window based on comparison of charging windows associated with different power sources.

The computer-implemented method in this aspect implements a single identified charging window is implemented.

The computer-implemented method in this aspect implements multiple identified charging windows.

The preference information in this aspect includes financial metrics and wherein the financial metrics include at least one of maximum charges, maximum charging rates, and selection of least cost charging window associated with multiple power sources.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1A depicts a block diagram of an illustrative environment for providing management of vehicle battery pack charging in accordance with one or more aspects of the present application;

FIG. 1B depicts a block diagram of a vehicle, including a battery pack for utilization of a vehicle battery pack management routine in accordance with aspects of the present application;

FIG. 2 depicts an illustrative architecture for implementing the charging management application on one or more local resources or a network service in accordance with aspects of the present application;

FIG. 3 is a flow diagram of an illustrative charging management routine implemented by a charging management application according to one or more aspects of the present application;

FIG. 4 is a flow diagram of an illustrative charging management routine utilizing multiple power sources in accordance with aspects of the present application; and

FIG. 5 is a flow diagram of a charging window determination routine for an identified power source according to one or more aspects of the present application.

### DETAILED DESCRIPTION

The following detailed description of certain embodiments presents various descriptions of specific embodiments. However, the innovations described herein can be embodied in a multitude of different ways, for example, as defined and covered by the claims. This description makes reference to the drawings where reference numerals can indicate identical or functionally similar elements. It will be understood that elements illustrated in the figures are not necessarily drawn to scale. Moreover, it will be understood that certain embodiments can include more elements than illustrated in a drawing and/or a subset of the illustrated elements. Further, some embodiments can incorporate any suitable combination of features from two or more drawings.

Generally described, one or more aspects of the present disclosure relate to the configuration and management of actions associated with the management of a device, such as an electric vehicle. By way of illustrative examples, aspects of the present application incorporate the management of charging processes associated with the delivery of energy to a vehicle-based battery pack from one or more available power sources. Illustratively, the charging processes can be defined in terms of an estimated charging window that corresponds to a minimum defined amount of time, based on environmental conditions, to achieve one or more defined charging parameters/goals. The charging parameters/goals can correspond to providing sufficient energy to the vehicle battery pack to achieve a threshold amount of charge (e.g., a partial charge or full charge), precondition the battery pack to achieve preferred operational status, establish defined vehicle environmental conditions (e.g., establish a defined cabin temperature or cabin temperature range, etc.), and the like. Still, further, aspects of the present application can further include the selection and management of a plurality of charging windows based on the incorporation of power consumption rate schedules for one or more power sources that include variable power consumption metrics (e.g., financial cost associated with access to the power source, transmission of energy from the power source, and the like).

Generally described, charging processes for devices, such as battery packs in electric vehicles or hybrid vehicles, typically correspond to manual processes. For example, a vehicle battery pack charging process can be initiated when the vehicle is connected to an external charging apparatus. Such process can be initiated automatically upon connection between the external charging apparatus and the vehicle or manually by the selection of a control by a user. In some scenarios, a user may be able to specify a start time for a vehicle charging process to begin. In accordance with manual charging processes or scheduling charging processes, the such charging process can be completed well in advance of the intended use of the vehicle. This can result in the charging process placing the vehicle battery pack in a higher charge level for longer periods of time, which can result in reduced life or performance of the battery pack. In other scenarios, if the manual process is initiated too late, the charging process may not be fully completed to achieve desired vehicle charging parameters. Accordingly, the desired vehicle charging parameters may not be completed prior to beginning the use of the vehicle. Still, further, manual processes are further inefficient due to variations of charging process efficiencies/timing caused by external environmental conditions, such as ambient temperature during the charging processes. These variations can result in either overcharging or undercharging, as described above. Still, further, manual processes can further be inefficient in situations in which one or more available power sources are associated with variable consumption metrics. For example, if a manual charging process or scheduled charging process is initiated during scheduled power source service interruptions or during a time period of limited available power from a power source, such charging processes may result in an undercharging scenario. In another example, a manual charging process or scheduled charging process may be initiated during times in which the user may be charged peak or premium rates.

To address at least a portion of the above-identified inefficiencies, a charging management application to facilitate the management and implementation of one or more charging windows is provided. Illustratively, the charging management application may be implemented by a variety of components, including local charging infrastructure equipment, user mobile device, vehicle interface devices, or local computing device. Additionally, in some embodiments, at least a portion of the charging management application may be implemented in accordance with a network service that may cooperate with the local charging infrastructure equipment, user mobile device, vehicle interface devices or local computing device.

The charging management application illustratively receives or determines an anticipated/desired time for the beginning operation of the vehicle. The charging management application obtains or identifies preferences for charging metrics, including desired charge, battery pack preconditioning, and other vehicle attributes. The charging management application then determines a required start time for the desired charging metrics. Illustratively, the determined start time can be based on ambient environmental conditions that can influence charging times, such as differences in charging times based on temperature. Additionally, the determined start time can be based on rate schedules for one or more power sources, such as one or more off-peak charging rates, peak charging rates, etc. For example, the charging management application can determine whether a start time can be selected during a time window of off-peak charging rates such that the desired charging metrics can be completed prior to the completion of the off-peak timing window.

In some embodiments, the charging management application can determine charging windows and associated costs for a set of available power sources for use in charging a battery pack, such as standard electrical connections provided by a service provider or pre-stored location power sources (e.g., stored energy from local solar power sources). Illustratively, if completion of the desired charging metrics cannot be achieved during a time window of off-peaking charging rates, the charging management application cant utilize user preferences to select a charging window that either completes the charging metrics based on time windows of corresponding to a combination of-peak and peak charging rates or that limits charging during a time window corresponding solely to off-peak charging rates but only partially achieves the desired charging metrics. Based on the determined charging window (and power source in some embodiments), the charging management application can then implement the charging process in accordance with the determined charging window.

Although the various aspects will be described in accordance with illustrative embodiments and a combination of features, one skilled in the relevant art will appreciate that the examples and combination of features are illustrative in nature and should not be construed as limiting. More specifically, aspects of the present application may be applicable to various types of vehicle charging mechanisms, power sources, interfaces and the like. However, one skilled in the relevant art will appreciate that the aspects of the present application are not necessarily limited to application to any particular type of vehicle, vehicle charging infrastructure, data communications or illustrative interaction between vehicles, owners/users, and a network service provider. Such interactions should not be construed as limiting.

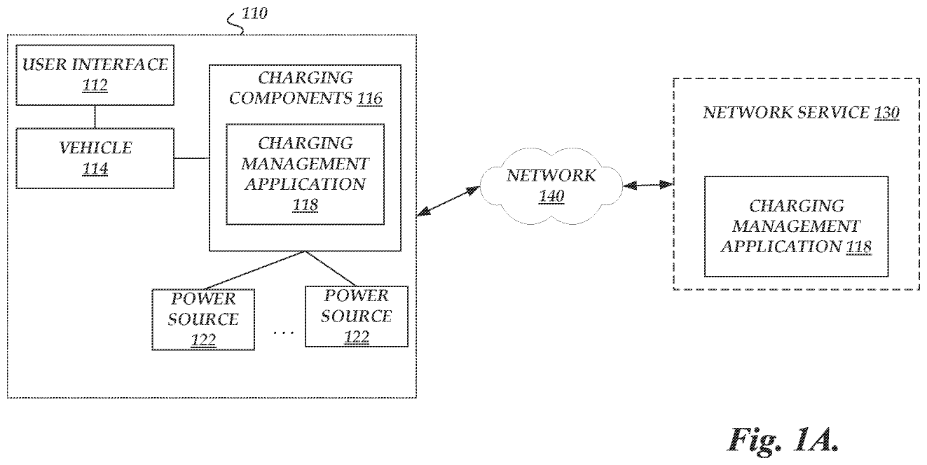

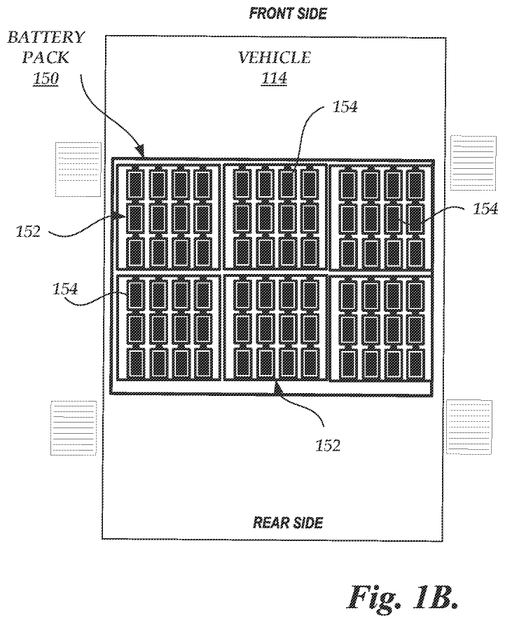

FIG. 1A illustrates a block diagram of an environment of a system 100. The system 100 corresponds to the management of vehicle charging in accordance with one or more aspects of the present application. The environment of the system 100 includes a collection of local resources 110 that may be utilized to provide electric charging functionality to electric devices, such as electric vehicles. The collection of local resources 110 can include one or more vehicles 114 that include connections for receiving electric charge from an external power source. The vehicles 114 may be associated with, or otherwise provide access to, user interfaces 112 for obtaining user inputs or information. The user interfaces 112 may be generated on interface equipment provided within the vehicle or via external computing devices accessed by a user of the vehicle, such as mobile devices, laptop computing devices, kiosks and the like. In this regard, reference to one or more vehicles 114 forming a portion of the local resources 110 can correspond to access to battery packs for use in the charging processes described herein or the utilization of interface(s) for managing charging processes. The vehicles 114 are not considered fixed to the local resources 110 and may be portions of multiple local resources 110. In some embodiments, if a battery pack may be separated from a corresponding device (e.g., a removable battery pack) or if the battery pack corresponds to a device not considered to be a vehicle 114, the vehicle 114 may be removed or missing from the local resources 110.

The local resources 110 can further include charging infrastructure equipment (e.g., charging components 116) that provide energy to the electric vehicle 114 via an energy transfer methodology, such as by direct physical coupling, wireless charging, or other energy transfer methodologies. The charging components 116 may be able to access power from at least one power source 122, such as electric current, voltage, or power provided by a third-party service provider. For example, the power source 112 may correspond to a charging component or device that can access power provided by a third-party service provider via a structure (e.g., power connections provided via a building). In some embodiments, the charging components 116 of a local resource 110 can include a plurality of power sources 122 that may be selectable individually or used in combination to provide energy to the battery pack. Illustratively, individual power source 122 may be associated with or defined in accordance with charging performance metrics (e.g., available energy or energy distribution rates) and charging rates (e.g., off-peak charging rates or peak charging rates). In some embodiments, individual power sources 122 may correspond to a common power source, but may be associated with different charging performance metrics or charging rates. In other embodiments, individual power sources 122 may correspond to different power sources, such as local stored energy sources (e.g., battery based storage), solar or wind-based power sources, and the like.

The local resources 110 further include a charging management application 118 that may be hosted on the charging components 116, vehicle, mobile device, etc. The charging management application 118 can obtain or maintain user preference information regarding desired charging metrics, desired vehicle operational parameters, and desired financial thresholds or preferences. The charging management application can further maintain charging performance metrics for individual power sources 112 available for providing energy to the vehicle. The charging management application 118 still can further determine charging windows for individual power sources 122 based on a combination of preferences and environmental conditions. The charging management application 118 can facilitate the execution of the specified/determined charging window and selected power source 122.

The local resources 110 are represented in a simplified, logical form and do not reflect all of the physical software and hardware components that may be implemented to provide the functionality associated with the local resources.

In some embodiments, the environment can further include a network service 130 provided that can communicate with one or more of the local resources 110 via network 140 connection. The network service 130 (e.g., one or more software applications or services hosted on computing resources provided by a network service provider) can implement a charging management application 118 that functions similarly to the charging management application 118 of the local resources 110 or in combination with the charging management application 118 of the local resources 110. In this regard, reference to a charging management application 118 will generally include reference to a charging management application in general without limiting to the execution environment, such as a mobile device, vehicle, network service, etc. One skilled in the relevant art will appreciate that the network service 130 is represented in a simplified, logical form and does not reflect all of the physical software and hardware components that may be implemented to provide the functionality associated with the network service 130.

The communication network 140 may be any wired network, wireless network, or combination thereof. In addition, the network may be a personal area network, local area network, wide area network, cable network, fiber network, satellite network, cellular telephone network, data network, or combination thereof. In the example environment of FIG. 1A, network is a global area network (GAN), such as the Internet. In some embodiments, the network 140 can be a wired communication network, such that the local resources 110 and the network service 130 are connected via wired communication using any one of the commercially available wired communication standards. In some embodiments, the network 140 is a wireless communication network. In these embodiments, the network 140 can use a short-range communication protocol, such as Bluetooth, Bluetooth low energy (“BLE”), and/or near field communications (“NFC”). The network 140 can comprise any combination of wired and/or wireless networks, such as one or more direct communication channels, local area network, wide area network, personal area network, and/or the Internet. In some embodiments, the network 140 may include one or more wireless networks, such as a Global System for Mobile Communications (GSM) network, a Code Division Multiple Access (CDMA) network, a Long Term Evolution (LTE) network, 5G communications, or any other type of wireless network. Network 140 can use protocols and components for communicating via the Internet or any of the other aforementioned types of networks. For example, the protocols used by the network 140 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein. In some embodiments, wireless communication via the network 154 may be performed on one or more secured networks, such as communicating with encrypting data via SSL (e.g., 256-bit, military-grade encryption). The various communication protocols discussed herein are merely examples, and the present disclosure is not limited thereto. Protocols and components for communicating via the other aforementioned types of communication networks are well known to those skilled in the art of computer communications and, thus, need not be described in more detail herein.

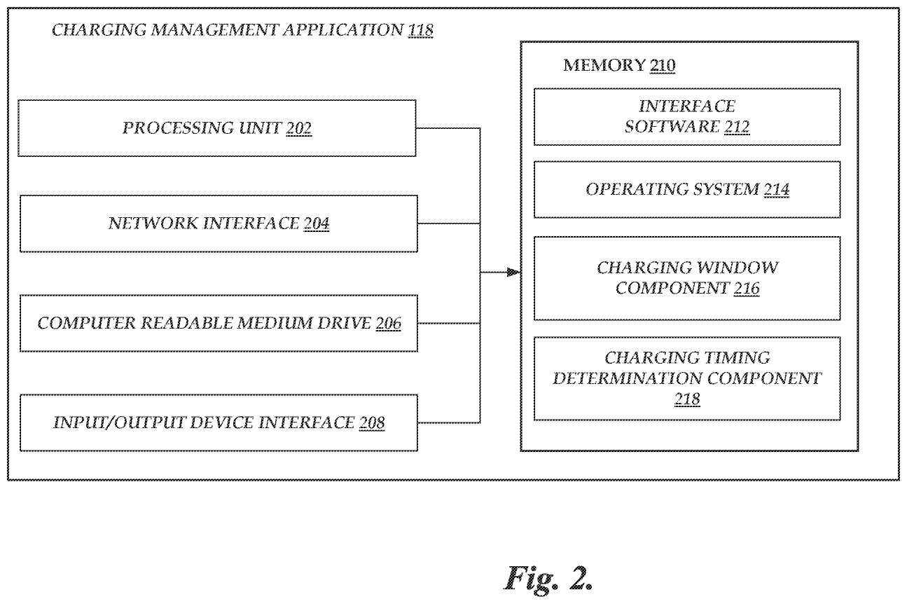

FIG. 11B shows one embodiment of a battery installed in a vehicle 114. As shown in FIG. 2, the vehicle 114 can include a battery pack 150, which may be generally referred to as a battery 150. In some embodiments, the battery 150 can include a plurality of individual groupings 152 of a plurality of battery cells 154. The configuration of the battery pack 150, battery groupings 152, and battery cells 154 can be determined based on specific applications. For example, in some embodiments, a vehicle 114 may be associated with a singular battery pack 150 that corresponds to a plurality of battery cells 154 such that a single charging process corresponds to the entire set of battery cells 154 corresponding to the battery pack 150. In other embodiments, the battery pack 150 may be organized into two or more groupings 152 such that each individual grouping 152 may be subject to an independent charging process that can be managed in accordance with aspects of the present application. Accordingly, the specific configuration of the battery pack 150, groupings 152 or plurality of cells 154 should be construed as limiting aspects of the present application.

With reference now to FIG. 2, an illustrative architecture for implementing the charging management application 118 on one or more local resources 110 or a network service 130 will be described. The architecture of FIG. 2 is illustrative in nature and should not be construed as requiring any specific hardware or software configuration for the charging management application. The general architecture of the charging management application 118 depicted in FIG. 2 includes an arrangement of computer hardware and software components that may be used to implement aspects of the present disclosure. As illustrated, the charging management application 118 includes a processing unit 202, a network interface 204, a computer readable medium drive 206, and an input/output device interface 208, all of which may communicate with one another by way of a communication bus. The components of the charging management application 118 may be physical hardware components or implemented in a virtualized environment.

The network interface 204 may provide connectivity to one or more networks or computing systems, such as the network 140 of FIG. 1A. The processing unit 202 may thus receive information and instructions from other computing systems or services via a network 140. The processing unit 202 may also communicate to and from memory 210 and further provide output information for an optional display via the input/output device interface 208. In some embodiments, the charging management application 118 may include more (or fewer) components than those shown in FIG. 2, such as implemented in a mobile device or vehicle.

The memory 210 may include computer program instructions that the processing unit 202 executes in order to implement one or more embodiments. The memory 210 generally includes RAM, ROM, or other persistent or non-transitory memory. The memory 210 may store an operating system 214 that provides computer program instructions for use by the processing unit 202 in the general administration and operation of the charging management application 118 via the interface software 212. The memory may further include computer program instructions and other information for implementing aspects of the present disclosure. For example, in one embodiment, the memory includes a charging window determining component 216 that is configured to receive requests for determining a charging window, select a charging window, and cause the implementation of the selected charging window. The memory 210 further includes a charging timing determination component 218 for determining individual charging timing windows and costs for one or more power sources as described herein and utilized to select the charging window. The charging management application 118 can maintain a plurality of data stores utilized in accordance with one or more aspects of the present application, including charging preferences for charging metrics, including desired charge, battery pack preconditioning and other vehicle attributes, performance metrics for individual power sources, and other information.

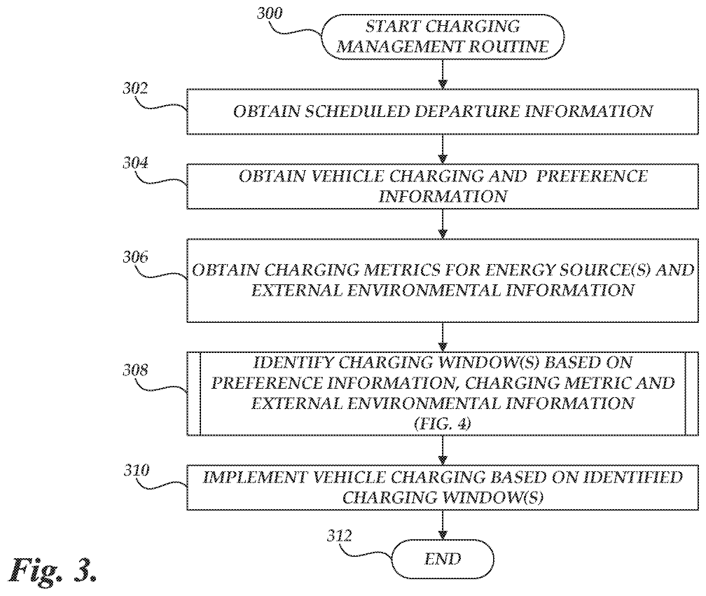

Turning now to FIG. 3, a flow diagram of a charging management routine 300 implemented by charging management application 118 will be described. Illustratively, routine 300 corresponds to the determination of charging windows for charging a battery pack based on anticipated use/need for the battery pack and user preferences regarding charging metrics and charging rates. At block 302, the charging management application 118 receives or determines an anticipated/desired time for the beginning operation of the vehicle 114. Illustratively, a user may utilize an interface 112 in the vehicle 114 or a mobile application to identify an anticipated/desired time for beginning the operation of vehicle 114. In other embodiment, the charging management application 118 may receive information or request information from third-party sources, such as a calendaring application, social media applications, etc. to determine the desired time. Still further, in other embodiments, the charging management application 118 may utilize learning algorithms, such as machine learning algorithms, that use historical information and output times characterized as likely desired/anticipated start times or departure times. For example, the learning algorithms can observe behavior based on user behavior patterns or based on different information/inputs that are available to the learning algorithm. The learning algorithm(s) may be integrated into the charging management application 118 or accessed as an external resource.

At block 304, the charging management application 118 obtains or identifies preference information for charging metrics, including desired charge, battery pack preconditioning and other vehicle attributes. Illustratively, the desired charge information for the battery pack can include categories of charge (e.g., full charge, half charge, etc.), numerical values or percentages, equivalent ranges of predicted or anticipated operational use (e.g., x number of miles), and the like. Illustratively, the battery pack preconditioning information specifies various operational patterns associated with the battery pack or electrical system that can be considered to provide optimal performance of the battery pack/electrical system. For example, the battery pack preconditioning information can correspond to a specific of temperature or temperature range associated with the battery pack operational parameters. As will be described, the preconditioning information may require the consumption of at least a portion of the battery pack charge to establish and maintain the temperature characteristics of the battery pack or other parameters. Illustratively, the charging metric information includes preference information related to financial criteria related to charging rates, total charges, or other information related to the charging of the battery pack.

At block 306, the charging management application 118 obtains charging metric information and external environment information for one or more power sources 122 available to provide energy to complete the charging of the vehicle 114. Illustratively, the power sources 122 may be associated with charging metrics that can include one or more charging rates, charging restrictions/availability information, and other information associated with utilization of the power source to charge the vehicle. The external environment information (e.g., external information) can illustratively correspond to charging models that define the functionality of charging components 116 (e.g., charging system) based on environmental conditions, such as temperature, humidity, etc. The external environment information may be defined according to categories of charging information based on a ranges of temperatures (or other inputs) or may be specified programmatically to define specific charging parameters as a function of inputted environmental conditions. Some or portions of the information may be maintained in locally accessible storage media or can be dynamically provided or updated via interfaces provided through the communication network 140.

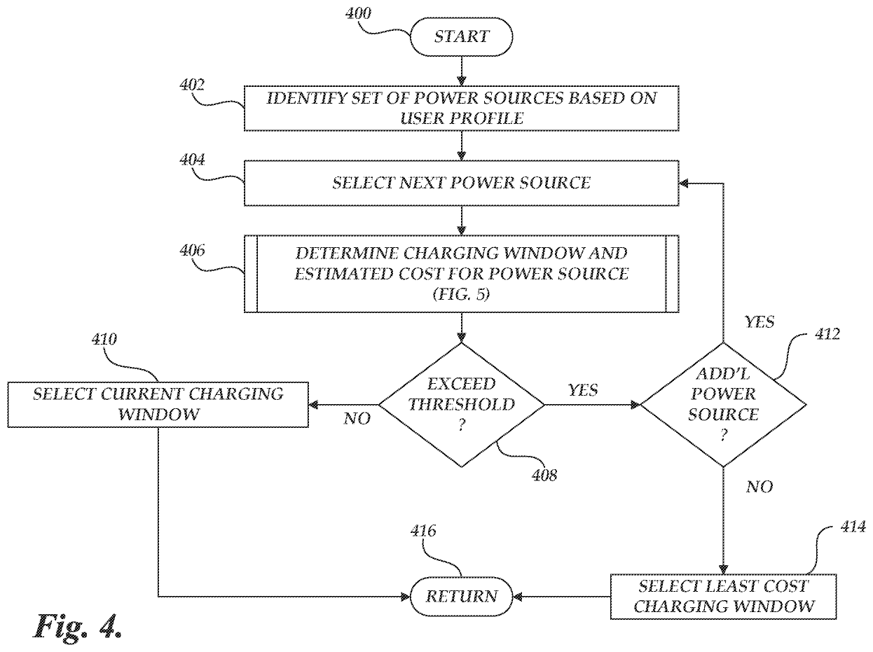

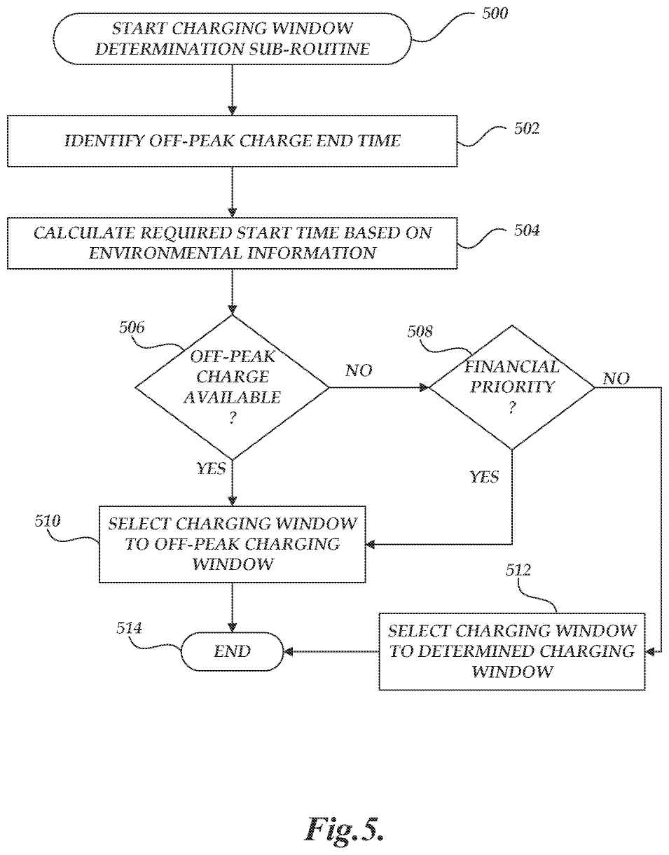

At block 308, the charging management application 118 identifies one or more charging windows based on the preference information, charging metric, and external environmental information. Illustratively, if more than one power source 122 is available, the charging management application 118 can select a charging window based on a comparison of charging windows associated with the different power sources 122. Illustrative processes for the selection of the charging windows will be described in greater detail with regard to FIGS. 4 and 5.

At block 310, the charging management application 118 implements the charging based on the identified charging window(s). As described above, in some embodiments, a single identified charging window may be implemented to achieve the desired battery pack charge. In other embodiments, a set of charging windows may be implemented to cumulatively achieve the desired battery pack charge (or exceed a threshold amount of charge). In some embodiments, the charging management application 118 can further provide information to the user, such as via a user interface 112, that identifies anticipated costs, cost comparison, charging completion, etc. At block 312, routine 300 terminates.

Turning now to FIG. 4, a routine 400 for identifying one or more charging windows based on the preference information, charging metric and external environmental information will be described. At block 402, the charging management application 118 identifies one or more charging power sources 122 that may be available to provide the charge. Illustratively, the power sources 122 can include one or more different types of power sources 122, such as a direct power line from a service provider, the direct charge from a local energy production component (e.g., solar energy or wind energy), stored power sources, such as battery or capacitor banks, and the like. As described above, in some embodiments, multiple power sources 122 may correspond to a common type of power source, such as multiple power sources 122 corresponding to a direct power line but having different charging characteristics (e.g., high power vs. low power) or charging metrics. In some embodiments, the charging management application 118 identifies a set of power sources based on user profile information. In these embodiments, the user profile information may limit otherwise available power sources, such as in the event of anticipated power outages or power consumption mitigation programs. Still further, if only a single power source is available, block 402 may be omitted or utilize a default power source 122.

Routine 400 then enters into an iterative routine to determine possible candidate charging windows based on the preference information, charging metric, and external environmental information for the set of identified, available power sources. At block 404, the charging management application 118 selects the next identified, available power source 122. At block 406, the charging management application 118 determines the charging window for the selected power source and an estimated cost for implementing the charging window. An illustrative routine for determining the charging window for individual power sources 122 will be described with regard to FIG. 5.

At decision block 408, a test is conducted by the charging management application 118 to determine whether the estimated cost exceeds a performance or financial threshold specified by the preference information. Illustratively, the performance threshold can correspond to performance metrics of the battery pack(s), such as charge status, etc., where the battery pack(s) are implemented within a vehicle 114. The financial threshold can correspond to maximum charges, maximum charging rates, or selecting the least cost charging window associated with multiple power sources. If the determined charging window does not exceed the threshold (or otherwise satisfies the criteria), at block 410, the charging management application 118 selects the determined charging window from the current power source, and the routine 400 returns to the charging window.

Alternatively, at decision block 408, if the determined charging window exceeds financial thresholds or if the charging management application 118 is attempting to identify the lowest cost charging window, at decision block 412, the charging management application 118 determines whether additional power sources should be evaluated. If so, the routine 400 returns to block 404 to determine charging windows for additional power sources. Alternatively, if no other power sources are available, the charging management application 118 can select the charging window that represents the least cost charging window at block 414. Illustratively, block 414 is implemented when no charging windows satisfy the established preference thresholds/criteria, but charging is still desired. In other embodiments, the charging management application 118 can determine that charging should not proceed or provide a notification to the user that no charging windows satisfy preference information. The charging management application 118 may obtain the confirmation or additional inputs from the user prior to proceeding. At block 416, the routine returns.

Turning now to FIG. 5, a routine 500 for determining a charging window for an identified power source (e.g., block 406 of FIG. 4) will be described. Illustratively, the charging management application 118 will first attempt to identify a charging window that will be completed entirely within the off-peak charging rates of the power source. Additionally, the charging amount can correspond to the required amount of energy to meet the specified charging level of the battery pack 150, the estimated energy utilized from the battery pack to achieve the specified preconditioning of the battery pack and the estimated energy utilized by the battery pack 150 to achieve the vehicle operational parameters (e.g., heating the vehicle cabin). In some embodiments, the charging amount can be limited to the energy to achieve the specified charging level and various combinations of additional charging requirements (or none at all). Illustratively, the time difference between the end of the time for off-peak charging and the anticipated time for vehicle operation (e.g., scheduled departure) may require additional or supplemental charge based on determining energy losses during such time difference.

At block 502, the charging management application 118 determines an off-peak charging rate end time based on the power source. Illustratively, the off-peak charging rate end time will represent the desired termination of the charging window. At block 504, the charging management application 118 calculates the required charging start time based on environmental information. As described above, individual energy sources can be associated with energy metric information that may indicate the energy that can be provided to the battery pack through the charging components. The energy that can be provided may be dependent on environmental conditions, which illustratively include ambient temperature. For example, the charging rate can be specified as a distribution of battery pack temperature, which is influenced by ambient temperature. Accordingly, the charging management application 118 can calculate a time required to achieve a desired charge amount based on ambient temperature, including as a function of an average temperature, schedule of predicted temperature values, etc. Based on the calculated start time, the charging management application 118 can then determine the calculated charging window (e.g., the length of time between the start time and the off-peak charging end time).

At decision block 506, the charging management application 118 determines whether the charging window corresponds to the off-peak charging rate time window. If so, the charging management application selects the determined charging window at block 510, and the routine returns at block 514. Alternatively, in some scenarios, the charging management application 118 may determine that the calculated start time exceeds the timing window available for off-peak charging or would otherwise start prior to a current time (e.g., not enough time is available in the off-peak timing window). In these embodiments, the charging management application 118 may determine that that the entirety of the charging window cannot be completed during off-peak charging rate timing windows.

At decision block 508, the charging management application 118 identifies financial priority information that can specify whether the user desires the use of peak charging rates to complete the desired charge. If so, the routine 500 proceeds to block 512, where the charging management application 118 selects a charging window to achieve the specified charging parameters. In this scenario, the charging window will overlap with peak charging rate timing windows or may incorporate a set of charging windows that can cumulatively provide desired charging results. Illustratively, individual charging windows may be associated with different charging rates. Alternatively, if the charging window should not include any peak charging rates and therefore result in the reduction of charge, the routine 500 proceeds to block 510 to determine a lesser charging window that occurs within the off-peak charging timing window. For example, the charging management application can eliminate vehicle operational parameters or limit battery pack preconditioning. In another example, the battery pack may be limited to less than what can be characterized as a full charge or the specified value. The routine 500 returns at block 514.

As described above, based on the determined charging window (and power source in some embodiments), the charging management application 118 can then implement the charging process in accordance with the determined charging window.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed air vent assembly. It is to be understood that the forms of the disclosure herein shown and described are to be taken as representative embodiments. Equivalent elements, materials, processes, or steps may be substituted for those representatively illustrated and described herein. Moreover, certain features of the disclosure may be utilized independently of the use of other features, all as would be apparent to one skilled in the art after having the benefit of this description of the disclosure. Expressions such as “including,” “comprising,” “incorporating,” “consisting of,” “have,” “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. A system for managing vehicle charging by implementing charging windows, the system comprising:
one or more computing processors and memories for executing computer-executable instructions to implement a charging management application, wherein the charging management application is configured to:
determine a desired time for beginning operation of a vehicle, wherein the vehicle is associated with a battery pack;
identify preference information for charging the battery pack associated with the vehicle, wherein the preference information includes a desired charging threshold;
identify charging metric information and external information for at least one power source operable to provide energy to the battery pack;
determine at least one charging window based at least on the preference information, the charging metric information, and the external information; and
implement battery pack charging from the at least one power source based on the determined at least one charging window.

2. The system as recited in claim 1, wherein the charging management application identifies the at least one charging window by:
identifying a plurality of charging power sources, wherein the charging power sources are available to provide energy to the battery pack;
selecting a first charging power source of the plurality of charging power sources;
determining a first charging window for the first charging power source and an estimated cost for implementing the first charging window;
in response to determining that the estimated cost exceeds a financial threshold identified in the preference information, selecting a second charging power source from the plurality of charging power sources; and
determining a second charging window for the second charging power source.

3. The system as recited in claim 2, wherein the charging management application determines at least the first charging window or the second charging window based on:
determining an off-peak charging rate end times based on a charging power source, wherein the off-peak charging rate end times represent a desired termination time of the at least one charging window;
calculating a required charging start time based at least on environmental information included in the identified external information, wherein the environmental information includes an ambient temperature;
determining the at least one charging window corresponding to the off-peak charging rate end times; and
in response to determining that the charging windows corresponding to the off-peak charging rate, selecting the first charging window or the second charging window from the at least one charging window.

4. The system as recited in claim 1, wherein the preference information includes at least one of desired charge information and battery pack preconditioning information, wherein the desired charge information includes at least one of categories of charge, numerical values corresponding to battery pack charging states, or equivalent ranges of operational uses for the vehicle associated with the battery pack, and wherein the battery pack preconditioning information includes operational patterns associated with the battery pack.

5. The system as recited in claim 1, wherein the at least one power source is associated with charging metrics, wherein the charging metrics include at least one of charging rates, charging restrictions, and information associated with a utilization of the power source to charge the vehicle.

6. The system as recited in claim 1, wherein the external information corresponds to charging models for generating battery pack charge states by application of power from the at least one power source, wherein the charging models define a functionality of the at least one power source.

7. The system as recited in claim 1, wherein the charging management application is further configured to select the at least one charging window based on comparison of charging windows associated with different power sources.

8. The system as recited in claim 1, wherein the charging management application implements a single identified charging window.

9. The system as recited in claim 1, wherein the charging management application implements multiple identified charging windows.

10. The system as recited in claim 1, wherein the preference information includes financial metrics and wherein the financial metrics include at least one of maximum charges, maximum charging rates, and selection of least cost charging window associated with multiple power sources.

11. A system for managing vehicle charging, the system comprising:
identifying preference information for charging a battery pack included in a vehicle;
identifying charging metric information and external information for at least one power source available for providing power to the battery pack; and
identifying at least one charging window based on anticipated use of the battery back and on the preference information, the charging metric information, and the external information.

12. The system as recited in claim 11, wherein identifying the at least one charging windows based on anticipated use of the battery back and on the preference information, the charging metric information, and the external information includes:
identifying a plurality of power sources available for providing power to the battery pack;
selecting a first charging power source from the plurality of power sources;
determining a first charging window for the first charging power source and an estimated cost for implementing the first charging window;
in response to determining that the estimated cost exceeds a threshold, selecting a second charging power source from the plurality of power sources; and
determining a second charging window for the second charging power source.

13. The system as recited in claim 12, wherein determining at least the first charging window or the second charging window includes:
determining an off-peak charging rate end times based on a charging power source, wherein the off-peak charging rate end times represent a desired termination time of charging windows corresponding to the anticipated use of the battery pack;
calculating a required charging start time based at least on environmental information, wherein the environmental information includes an ambient temperature;
determining charging windows corresponding to the off-peak charging rate end times; and
in response to determining that the charging windows corresponding to the off-peak charging rate, selecting the first charging window or the second charging window from the charging windows corresponding to the off-peak charging rate.

14. The system as recited in claim 11, wherein the preference information includes at least one of desired charge information and battery pack preconditioning information, wherein the desired charge information includes categories of charge, numerical values, and/or equivalent ranges of operational uses, and wherein the battery pack preconditioning information includes operational patterns associated with the battery pack.

15. The system as recited in claim 11, wherein the power source is associated with charging metrics, wherein the charging metrics include at least one of charging rates, charging restrictions, and information associated with a utilization of the power source to charge the vehicle.

16. The system as recited in claim 11, wherein the external information corresponds to charging models, wherein the charging models define a functionality of charging components.

17. The system as recited in claim 11, wherein the preference information includes financial metrics and wherein the financial metrics include at least one of maximum charges, maximum charging rates, and selection of least cost charging window associated with multiple power sources.

18. A computer-implemented method for managing vehicle charging, the method comprising:
determining a desired time for beginning operation of a vehicle;
identifying preference information for charging battery packs included in the vehicle;
identifying charging metric information and external information for at least one power source;
identifying at least one charging window based at least on the desired time for beginning the operation of the vehicle, the preference information, the charging metric information, and the external information; and
implementing vehicle charging based on the identified at least one charging window.

19. The computer-implemented method of claim 18, wherein the identification of the at least one charging window comprising:
identifying a plurality of charging power sources, wherein the charging power sources are available to provide an electrical charge to the vehicle;
selecting a first charging power source of the plurality of power sources;
determining a first charging window for the first charging power source and an estimated cost for implementing the first charging window;
in response to determining that the estimated cost exceeds a threshold, selecting a second charging power source from the plurality of power sources; and
determining a second charging window for the second charging power source.

20. The computer-implemented method of claim 19, wherein determining at least the first charging window or the second charging window includes:
determining an off-peak charging rate end times based on the charging power source, wherein the off-peak charging rate end times represent a desired termination time of the charging windows;
calculating a required charging start time based at least on environmental information, wherein the environmental information includes an ambient temperature;
determining charging windows corresponding to the off-peak charging rate end times; and
in response to determining that the charging windows corresponding to the off-peak charging rate, selecting the first charging window or the second charging window from the charging windows corresponding to the off-peak charging rate end times.

21. The computer-implemented method of claim 18, wherein the preference information includes at least one of desired charge information and battery pack preconditioning information, wherein the desired charge information includes categories of charge, numerical values, and/or equivalent ranges of operational uses, and wherein the battery pack preconditioning information includes operational patterns associated with the battery pack.

22. The computer-implemented method of claim 18, wherein the power source is associated with charging metrics, wherein the charging metrics include at least one of charging rates, charging restrictions, and information associated with a utilization of the power source to charge the vehicle.

23. The computer-implemented method of claim 18, wherein the external information corresponds to charging models, wherein the charging models define a functionality of charging components.

24. The computer-implemented method of claim 18, wherein the method further configured to select the at least one charging window based on comparison of charging windows associated with different power sources.

25. The computer-implemented method of claim 18, wherein a single identified charging window is implemented.

26. The computer-implemented method of claim 18, wherein multiple identified charging windows are implemented.

27. The computer-implemented method of claim 18, wherein the preference information includes financial metrics and wherein the financial metrics include at least one of maximum charges, maximum charging rates, and selection of least cost charging window associated with multiple power sources.
